(19) United States
(12) Patent Application Publication
(10) Pub. No.: US 2021/0346758 A1
(43) Pub. Date: Nov. 11, 2021

(54) Kegel Trainer

(71) Applicant: Junhua Ge, Ningbo (CN)

(72) Inventor: Junhua Ge, Ningbo (CN)

(21) Appl. No.: 16/902,261

(22) Filed: Jun. 15, 2020

(30) Foreign Application Priority Data
May 6, 2020 (CN) 202020725969.6

(51) Int. Cl. A63B 23/20; A63B 21/00; A61H 23/02; A63B 21/05

(52) U.S. Cl. CPC A63B 23/20; A63B 21/00069; A61H 2201/5043; A63B 21/05; A63B 21/4035; A61H 23/02

(57) ABSTRACT

A Kegel trainer includes a frame, two tensioning plates provided at an end of the frame, and a rubber cover sleeved outside the frame and the two tensioning plates. The tensioning plates are provided with arc-shaped warped portions. The two tensioning plates are provided therebetween with a separating chamber. The separating chamber is provided therein with a slidable adjusting mechanism. The adjusting mechanism includes a retaining plate assembly. The retaining plate assembly is provided with a fixed hollow tube assembly. The fixed hollow tube assembly is provided with a slide hole. The slide hole is provided therein with a movable ejector pin. The ejector pin is provided with a compressed spring. The frame is provided with a rack, a battery, a vibration machine, and a circuit board. The circuit board is provided with a switch, a charging port, and an indicator light.

### CROSS REFERENCE TO RELATED APPLICATIONS

The present application claims the benefit of Chinese Patent Application No. 202020725969.6 filed on May 6, 2020, the contents of which are incorporated herein by reference in their entirety.

### FIELD OF THE INVENTION

The present disclosure relates to the field of fitness equipment, and in particular to a Kegel trainer.

### BACKGROUND OF THE INVENTION

Kegel exercises, also known as pelvic exercises, were published by American physician Arnold Kegel in 1948. The purpose of Kegel exercises is to strengthen muscle tension by stretching the pubococcygeus of the pelvic floor. Kegel exercises are prescribed exercises for pregnant women to prepare the pelvic floor for physiologic pressure to be produced for example at a later stage of pregnancy and by delivery.

Currently there is no corresponding Kegel training instrument on the market, and it is necessary to design a Kegel training instrument by a technician.

### SUMMARY OF THE INVENTION

An objective of the present disclosure is to provide a Kegel trainer. The Kegel trainer has a frame and tensioning plates that can be placed between inner thighs. Relevant muscles can be exercised by using thighs and hips to clench and loose the tensioning plates.

In order to achieve the above objective, the present disclosure adopts the following technical solution: a Kegel trainer, including a frame, two tensioning plates provided at an end of the frame, and a rubber cover sleeved outside the frame and the two tensioning plates. The tensioning plates are provided with arc-shaped warped portions, and the two tensioning plates are provided therebetween with a separating chamber. The separating chamber is provided therein with a slidable adjusting mechanism. The adjusting mechanism includes a retaining plate assembly. The retaining plate assembly is provided with a fixed hollow tube assembly. The fixed hollow tube assembly is provided with a slide hole. The slide hole is provided therein with a movable ejector pin. The ejector pin is provided with a compressed spring. The frame is provided with a rack, a battery, a vibration machine, and a circuit board. The circuit board is provided with a switch, a charging port, and an indicator light. The rack is provided with a plurality of teeth and tooth sockets. The ejector pin is capable of being engaged into the tooth sockets.

As an improvement to the present disclosure, the retaining plate assembly is provided with a first guiding rod and rounded rectangular first guiding grooves, and the frame is provided with two fixing plates which are provided with a second guiding rod and rounded rectangular second guiding grooves. The first guiding rod is slidably connected with the second guiding grooves, and the second guiding rod is slidably connected with the first guiding grooves. The first guiding rod and the second guiding rod move in straight lines in the second guiding grooves and the first guiding grooves respectively. This ensures a rectilinear movement of the adjusting mechanism.

As a further improvement to the present disclosure, the two tensioning plates are provided therebetween with a fixed pulling plate and a fixed pulling rod. The pulling plate is fixedly connected with the two fixing plates respectively. The pulling plate and the pulling rod fixedly connect the tensioning plates and the frame together.

As a further another improvement to the present disclosure, the retaining plate assembly is provided with a first supporting hole at which a supporting block is provided. The supporting block is provided with a second supporting hole running through the first supporting hole. Both the first supporting hole and the second supporting hole are slidably connected with the rack. The retaining plate assembly and the supporting block can make rectilinear movement together along the rack. A contacting area between the supporting block and the rack is relatively large, which has an effect of supporting the retaining plate assembly to thereby prevent the retaining plate assembly from tilting.

As a further another improvement to the present disclosure, the retaining plate assembly includes an outer retaining plate and an inner retaining plate fixedly connected with the outer retaining plate. The inner retaining plate is provided with a connecting hole for fixing the hollow tube assembly. When being clenched by thighs, the tensioning plates deform and a distance between the two tensioning plates becomes smaller, and the outer retaining plate also deforms. To provide the inner retaining plate is to increase a thickness of the outer retaining plate, and in this case, it is required that the thighs clench the tensioning plates with a larger tensioning force to cause an elastic deformation of the tensioning plates and the outer retaining plate.

As a further another improvement to the present disclosure, the hollow tube assembly includes a lower sleeve and an upper sleeve in threaded connection with the lower sleeve. An upper end of the spring is fitted against the upper sleeve, and a lower end of the spring is fitted against the ejector pin, by way of which the spring is compressed.

As a further another improvement to the present disclosure, the ejector pin is provided with a step portion and a pointed portion. The pointed portion is capable of being engaged into the tooth sockets, and the step portion is fitted against an end of the spring. The spring presses against the step portion so that the ejector pin is pressed tightly against the tooth sockets.

As a further another improvement to the present disclosure, the spring is provided at an upper end thereof with a handle which can facilitate holding by a user.

As a further another improvement to the present disclosure, the frame includes a left housing and a right housing, and the rack is provided with a fixing hole. The left housing and the right housing are provided with a left fixing column and a right fixing column respectively for connecting the fixing hole. In this way, an end of the rack close to the fixing hole can be fastened by the left housing and the right housing.

As a further another improvement to the present disclosure, the vibration machine includes a motor and an eccentric block, and the frame is provided with a massage portion. The eccentric block is provided close to the massage portion. The massage portion touches and massages a body. When rotating, the eccentric block causes the frame to vibrate. Providing the eccentric block close to the massage portion can result in stronger vibration of the massage portion.

The present disclosure is advantageous in its simple structure and easy operation by a user. When the present disclosure is used, upper portions of inner thighs are used to clench the present disclosure, and at this moment, the tensioning plates are located under hips. Then adductors and gluteus maximus are used to clench the tensioning plates with a gradually increasing force to decrease a distance between the two tensioning plates, and at this point, the pubococcygeus is also caused to move indirectly. After the thighs and hips clench the tensioning plates, the warped portions of the tensioning plates deform elastically, and a force needed by the thighs and hips to cause the tensioning plates to deform can be adjusted by means of the adjusting mechanism. A principle underlying this is that the closer the adjusting mechanism is to the warped portions, the larger the needed force is, while the farther the adjusting mechanism is to the warped portions, the smaller the needed force is. This conforms to the lever principle, and the adjusting mechanism is equivalent to a pivot of a lever. After the adjusting mechanism slides, the adjusting mechanism is limited and locked by way of engaging the ejector pin into the tooth sockets. This provides the adjusting mechanism with a multi-position adjustment function. When it is necessary to adjust a position of the adjusting mechanism, the ejector pin is pulled up by hand so that the ejector pin disengages from the tooth sockets. After the position is adjusted, the ejector pin is subjected to an elastic force of the spring and is again engaged into the tooth sockets. The rubber cover is made of a silica gel material and is soft and comfortable. The vibration machine provides the present disclosure with a massage function. The vibration machine can be switched on by means of a switch. The battery can be a rechargeable battery, and the battery can be charged by inserting a USB cable into the charging port. The battery is thus reusable. The indicator light can remind the user that the trainer is being charged or is working.

### BRIEF DESCRIPTION OF THE DRAWINGS

FIG. 1 schematically shows an exploded view of the present disclosure;

FIG. 2 schematically shows an exploded view of an adjusting mechanism;

FIG. 3 schematically shows a sectional view of the adjusting mechanism;

FIG. 4 schematically shows a sectional view of the present disclosure when the adjusting mechanism is at a largest distance from a tensioning plate; and

FIG. 5 schematically shows a sectional view of the present disclosure when the adjusting mechanism is at a smallest distance from the tensioning plate.

### DETAILED DESCRIPTION OF THE EMBODIMENTS

The present disclosure will be described in detail below in conjunction with the accompanying drawings and embodiments in order to make the objectives, technical solutions, and advantages of the present disclosure clearer. It shall be appreciated that the specific embodiments described herein are only for the purpose of illustrating rather than limiting the present disclosure.

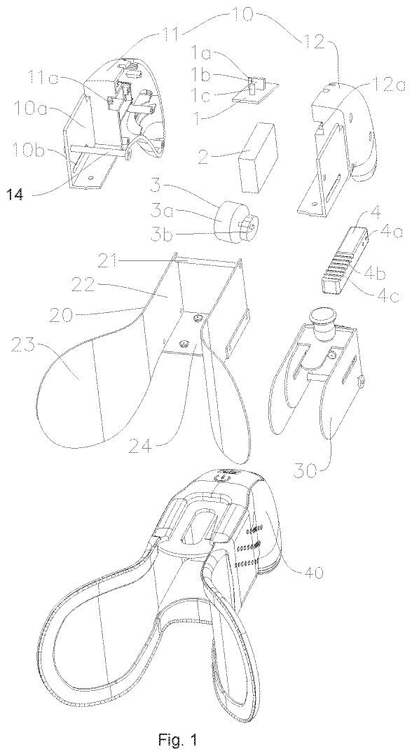

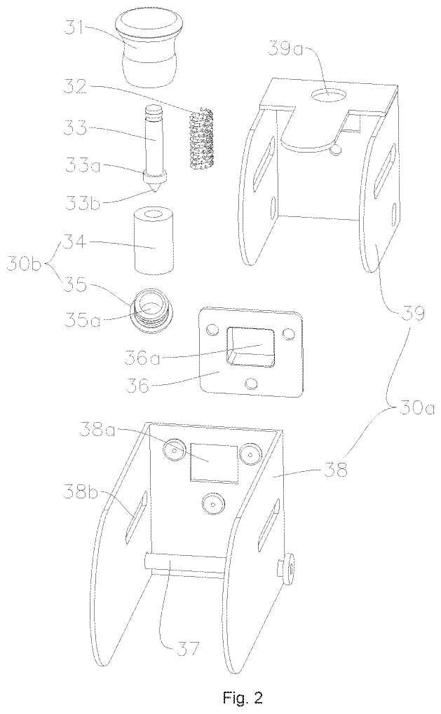

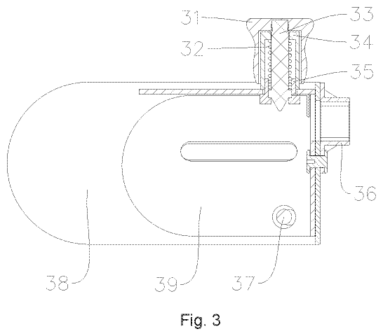

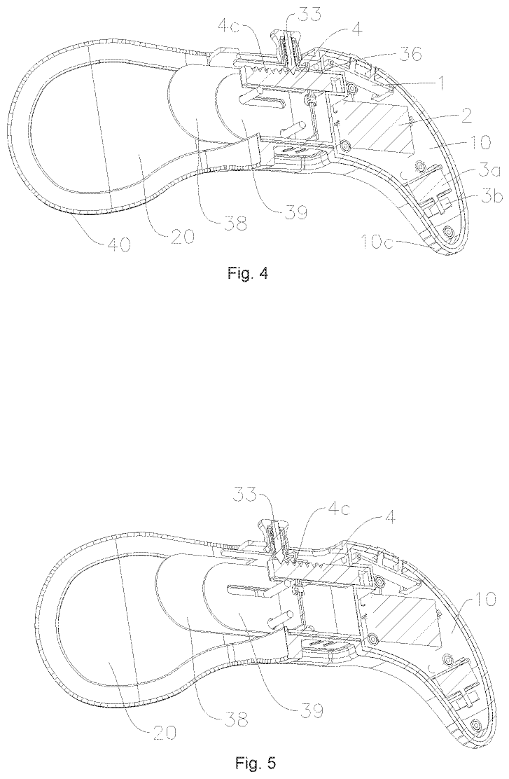

As shown in FIGS. 1 to 5, a Kegel trainer includes a frame 10, two tensioning plates 20 provided at an end of the frame 10, and a rubber cover 40 sleeved outside the frame 10 and the two tensioning plates 20. The tensioning plates 20 are provided with arc-shaped warped portions 23 respectively. The two tensioning plates 20 are provided therebetween with a separating chamber 22. The separating chamber 22 is provided therein with a slidable adjusting mechanism 30. The adjusting mechanism 30 includes a retaining plate assembly 30a. The retaining plate assembly 30a is provided with a fixed hollow tube assembly 30b. The hollow tube assembly 30b is provided with a slide hole 35a. The slide hole 35a is provided therein with a movable ejector pin 33. The ejector pin 33 is provided with a compressed spring 32. The frame 10 is provided with a rack 4, a battery 2, a vibration machine 3, and a circuit board 1. The circuit board 1 is provided with a switch lc, a charging port 1b, and an indicator light 1a. The rack 4 is provided with a plurality of teeth 4b and tooth sockets 4c. The ejector pin 33 is capable of being engaged into the tooth sockets 4c.

The retaining plate assembly 30a is provided with a first guiding rod 37 and rounded rectangular first guiding grooves 38b. The frame 10 is provided with two fixing plates 10a. The fixing plates 10a are provided with a second guiding rod 14 and rounded rectangular second guiding grooves 10b. The first guiding rod 37 is slidably connected with the second guiding grooves 10b, and the second guiding rod 14 is slidably connected with the first guiding grooves 38b.

The two tensioning plates 20 are provided therebetween with a fixed pulling plate 24 and a fixed pulling rod 21. The pulling plate 24 is fixedly connected with the two fixing plates 10a respectively.

The retaining plate assembly 30a is provided with a first supporting hole 38a at which a supporting block 36 is provided. The supporting block 36 is provided with a second supporting hole 36a running through the first supporting hole 38a. Both the first supporting hole 38a and the second supporting hole 36a are slidably connected with the rack 4.

The retaining plate assembly 30a includes an outer retaining plate 38 and an inner retaining plate 39 fixedly connected with the outer retaining plate 38. The inner retaining plate 39 is provided with a connecting hole 39a for fixing the hollow tube assembly 30b.

The hollow tube assembly 30b includes a lower sleeve 35 and an upper sleeve 34 in threaded connection with the lower sleeve 35.

The ejector pin 33 includes a step portion 33a and a pointed portion 33b. The pointed portion 33b is capable of being engaged into the tooth sockets 4c. The step portion 33a is fitted against an end of the spring 32.

The spring 32 is provided at an upper end thereof with a handle 31.

The frame 10 includes a left housing 11 and a right housing 12. The rack 4 is provided with a fixing hole 4a. The left housing 11 and the right housing 12 are provided with a left fixing column 11a and a right fixing column 11b respectively for connecting the fixing hole 4a.

The vibration machine 3 includes a motor 3a and an eccentric block 3b. The frame is provided with a massage portion 10c. The eccentric block 3b is provided close to the massage portion 10c.

The above described embodiments are merely preferred embodiments of the present disclosure and are not intended for limiting the present disclosure. Modifications, equivalent substitutions, and improvements made within the spirit and principles of the present application shall all fall within the protection scope of the present disclosure.

1. A Kegel trainer, comprising a frame, two tensioning plates provided at an end of the frame, and a rubber cover sleeved outside the frame and the two tensioning plates, wherein the tensioning plates are provided with arc-shaped warped portions, and the two tensioning plates are provided therebetween with a separating chamber, the separating chamber being provided therein with a slidable adjusting mechanism, the adjusting mechanism comprising a retaining plate assembly, the retaining plate assembly being provided with a fixed hollow tube assembly, the fixed hollow tube assembly being provided with a slide hole, the slide hole being provided therein with a movable ejector pin, the ejector pin being provided with a compressed spring; and
wherein the frame is provided with a rack, a battery, a vibration machine, and a circuit board, the circuit board being provided with a switch, a charging port, and an indicator light, the rack being provided with a plurality of teeth and tooth sockets, the ejector pin being capable of being engaged into the tooth sockets.

2. The Kegel trainer according to claim 1, wherein the retaining plate assembly is provided with a first guiding rod and rounded rectangular first guiding grooves, and the frame is provided with two fixing plates, the fixing plates being provided with a second guiding rod and rounded rectangular second guiding grooves, wherein the first guiding rod is slidably connected with the second guiding grooves, and the second guiding rod is slidably connected with the first guiding grooves.

3. The Kegel trainer according to claim 2, wherein the two tensioning plates are provided therebetween with a fixed pulling plate and a fixed pulling rod, the pulling plate being fixedly connected with the two fixing plates respectively.

4. The Kegel trainer according to claim 1, wherein the retaining plate assembly is provided with a first supporting hole at which a supporting block is provided, the supporting block being provided with a second supporting hole running through the first supporting hole, wherein both the first supporting hole and the second supporting hole are slidably connected with the rack.

5. The Kegel trainer according to claim 1, wherein the retaining plate assembly comprises an outer retaining plate and an inner retaining plate fixedly connected with the outer retaining plate, the inner retaining plate being provided with a connecting hole for fixing the hollow tube assembly.

6. The Kegel trainer according to claim 1, wherein the hollow tube assembly comprises a lower sleeve and an upper sleeve in threaded connection with the lower sleeve.

7. The Kegel trainer according to claim 1, wherein the ejector pin comprises a step portion and a pointed portion, the pointed portion being capable of being engaged into the tooth sockets, and the step portion being fitted against an end of the spring.

8. The Kegel trainer according to claim 1, wherein the spring is provided at an upper end thereof with a handle.

9. The Kegel trainer according to claim 1, wherein the frame comprises a left housing and a right housing, and the rack is provided with a fixing hole, the left housing and the right housing being provided with a left fixing column and a right fixing column respectively for connecting the fixing hole.

10. The Kegel trainer according to claim 1, wherein the vibration machine comprises a motor and an eccentric block, and the frame is provided with a massage portion, the eccentric block being provided close to the massage portion.
